(19) United States
(12) Patent Application Publication
(10) Pub. No.: US 2025/0053419 A1
(43) Pub. Date: Feb. 13, 2025

(54) METHOD AND SYSTEM FOR ACCELERATING RECURRENT NEURAL NETWORK BASED ON CORTEX-M PROCESSOR, AND MEDIUM

(71) Applicant: HANGZHOU VANGO TECHNOLOGIES, INC., Hangzhou (CN)

(72) Inventors: Yang REN, Hangzhou (CN); Honglei LIANG, Hangzhou (CN); Changyou MEN, Hangzhou (CN); Junhu XIA, Hangzhou (CN); Nianxiong TAN, Hangzhou (CN)

(73) Assignee: HANGZHOU VANGO TECHNOLOGIES, INC., Hangzhou (CN)

(21) Appl. No.: 18/932,723

(22) Filed: Oct. 31, 2024

Related U.S. Application Data
(63) Continuation-in-part of application No. 17/918,572, filed on Oct. 13, 2022.

(30) Foreign Application Priority Data
Dec. 29, 2021 (CN) 202111641429.5

(51) Int. Cl. G06F 9/30; G06N 3/044

(52) U.S. Cl. CPC G06F 9/3001; G06F 9/3013; G06N 3/044

(57) ABSTRACT

The application relates to a method and a system for accelerating a recurrent neural network based on a Cortex-M processor, and a medium. The method comprises: setting MCR instructions and a CDP instruction according to common basic operators of the recurrent neural network, the common basic operators comprising a matrix multiplication operator, a vector arithmetic operator, a sigmoid activation operator, a tanh activation operator and a quantization operator; configuring an internal register of a recurrent neural network coprocessor through the MCR instructions; and enabling the common basic operators of the recurrent neural network through the CDP instruction on the basis of the configured internal register.

### CROSS-REFERENCE TO RELATED APPLICATIONS

This application is the continuation-in-part application of the U.S. application Ser. No. 17/918,572 filed on 13 Oct. 2022 that is the U.S. national phase of International Application No. PCT/CN2022/077861 filed on 25 Feb. 2022 which designated the U.S. and claims priority to Chinese Application No. CN 202111641429.5 filed on 29 Dec. 2021, the entire contents of each of which are hereby incorporated by reference.

### TECHNICAL FIELD

The present application relates to the technical field of deep learning, and more particularly, to a method and system for accelerating a recurrent neural network based on a Cortex-M processor, and a medium.

### BACKGROUND

With the continuous innovation of science and technology, new artificial intelligence algorithms emerge endlessly, which greatly improve the social production efficiency and facilitate people's daily life. As one of the artificial intelligence network structures, a recurrent neural network plays an important role in Natural Language Processing (NLP), such as speech recognition, language modeling, text translation, and the like, and is also often used in various time series forecasting, such as weather forecasting and stock forecasting. Compared with a convolutional neural network which focuses on spatial expansion, that is, all inputs (comprising outputs) of which are independent of each other, the recurrent neural network focuses on temporal expansion, that is, can mine time series information and semantic information in data, and each output depends on the previous calculation results to some extent. Basic operations in the neural network comprise matrix multiplication, vector multiplication, vector addition, sigmoid activation and tanh activation.

In the solution of the prior art, data to be processed is sent to the cloud, and a result is returned to a user end after the calculation, and the general workflow of the solution of the prior art comprises the steps of edge data acquisition, edge data transmission, cloud data reception, cloud data processing, cloud data transmission, edge data reception, and the like. There are also processors that directly use a high-performance Microcontroller Unit (MCU) to directly handle these operations or design dedicated hardware accelerators. However, the collaborative processing between cloud and edge has the problems of bandwidth of data transmission, and low timeliness. High performance MCU has high cost; while the hardware accelerator designed for a specific algorithm has a fixed and inflexible structure.

At present, there is no effective solution to solve the problems of low efficiency, high cost and inflexibility of the recurrent neural network algorithm in the execution of the processor.

### SUMMARY

The embodiments of the present application provide a method and system for accelerating a recurrent neural network based on a Cortex-M processor, and a medium, so as to at least solve the problems of low efficiency, high cost and inflexibility of the recurrent neural network algorithm in the execution of the processor in the related art.

According to a first aspect, an embodiment of the present application provides a method for accelerating a recurrent neural network based on a Cortex-M processor, wherein the method comprises:
setting MCR ((Move to Coprocessor from arm Register) instructions and a Coprocessor Data Processing (CDP) instruction according to common basic operators of the recurrent neural network, wherein the common basic operators comprise a matrix multiplication operator, a vector arithmetic operator, a sigmoid activation operator, a tanh activation operator and a quantization operator;
configuring an internal register of a recurrent neural network coprocessor through the MCR instructions; and
enabling the common basic operators of the recurrent neural network through the CDP instruction on the basis of the configured internal register.

Recurrent neural network coprocessor configures its internal registers through MCR (Move to Coprocessor from arm Register) instructions, and reads its internal registers through the MRC (Move to arm Register from Coprocessor) instruction. A MCR instruction is one of the coprocessor instructions of ARM Company, which is used to transfer data from the general register of ARM processor to the register of coprocessor. This is a write operation, which is usually used to set the state of the coprocessor or configure its control register. A MRC instruction is used to transfer data from coprocessor to general register of ARM core processor. This instruction is usually used to read the state of the coprocessor or the value of its internal register. Recurrent neural network coprocessor starts the corresponding artificial intelligence operation through a CDP (Coprocessor Data Processing) instruction, which is also one of ARM coprocessor instructions and is used to instruct the coprocessor to perform data processing operations.

In some embodiments, the step of configuring the internal registers of the recurrent neural network coprocessor through the MCR instructions comprises:
configuring a local buffer address of weight data to a first register, configuring a local buffer address of feature data to a second register, configuring stride block information to a scale register, and configuring an operation mode and a write-back precision to a control register through a first MCR instruction;
configuring a local buffer address of a first vector set to the first register, configuring a local buffer address of a second vector set to the second register, configuring a local buffer address of write-back information to a third register, and configuring the stride block information to the scale register through a second MCR instruction; and
configuring a local buffer address of input data to the first register, configuring the local buffer address of the write-back information to the second register, and configuring the stride block information to the scale register through a third MCR instruction.

In some embodiments, after the step of configuring the internal register of the recurrent neural network coprocessor through the first MCR instruction, the method further comprises:
enabling the matrix multiplication operator of the recurrent neural network through the CDP instruction, partitioning a matrix of the feature data according to the stride block information, and partitioning a matrix of the weight data according to a preset weight quantity; and
performing a corresponding multiply and accumulate operation on the partitioned matrix of the feature data and the partitioned matrix of the weight data according to the operation mode.

In some embodiments, after the step of configuring the internal register of the recurrent neural network coprocessor through the second MCR instruction, the method further comprises:
enabling the vector arithmetic operator of the recurrent neural network through the CDP instruction, and adding or multiplying values in the first vector set and the second vector set one by one according to the stride block information; and
writing an arithmetic result back to a local buffer according to the write-back information.

In some embodiments, after the step of configuring the internal register of the recurrent neural network coprocessor through the third MCR instruction, the method further comprises:
enabling the sigmoid activation operator of the recurrent neural network through the CDP instruction, inputting the input data into a sigmoid activation function sigmoid

$$( X ) = \frac{1}{1 + {e}^{- x}}$$

according to the stride block information, and returning a result value; and
writing the result value back to a local buffer according to the write-back information. after the step of configuring the internal register of the recurrent neural network coprocessor through the third MCR instruction, the method further comprises: enabling the Tanh activation operator of the recurrent neural network through the CDP instruction, inputting the input data into a Tanh activation function tanh

$$( X ) = \frac{{e}^{x} - {e}^{- x}}{{e}^{x} + {e}^{- x}} = 2$$

sigmoid(2x)−1 according to the stride block information, and returning a result value; and
writing the result value back to a local buffer according to the write-back information.

In some embodiments, after the step of configuring the internal register of the recurrent neural network coprocessor through the third MCR instruction, the method further comprises:
enabling the quantization operator of the recurrent neural network through the CDP instruction, and converting a 32-bit single-precision floating-point number conforming to an IEEE-754 standard in the input data into a 16-bit integer according to the stride block information, or converting a 16-bit integer in the input data into a 32-bit single-precision floating-point number conforming to the IEEE-754 standard; and
writing a conversion result back to a local buffer according to the write-back information.

In some embodiments, the method further comprises:
configuring a main memory address to a first register, configuring a local buffer address to a second register, and configuring stride block information to a scale register through a fourth MCR instruction;
enabling a data reading operation through the CDP instruction, and reading data in the main memory address into the local buffer according to the stride block information; and
enabling a data writing operation through the CDP instruction, and writing data in the local buffer into the main memory address according to the stride block information.

According to a second aspect, an embodiment of the present application provides a system for accelerating a recurrent neural network based on a Cortex-M processor, wherein the system comprises an instruction set setting module and an instruction set execution module;
the instruction set setting module sets MCR instructions and a CDP instruction according to common basic operators of the recurrent neural network, wherein the common basic operators comprise a matrix multiplication operator, a vector arithmetic operator, a sigmoid activation operator, a tanh activation operator and a quantization operator;
the instruction set execution module configures an internal register of a recurrent neural network coprocessor through the MCR instructions; and
the instruction set execution module enables the common basic operators of the recurrent neural network through the CDP instruction on the basis of the configured internal register.

According to a third aspect, an embodiment of the present application provides a computer-readable storage medium storing a computer program thereon, wherein the computer program, when executed by a processor, implements the method for accelerating the recurrent neural network based on the Cortex-M processor according to the first aspect above.

Compared with the related art, the method and system for accelerating the recurrent neural network based on the Cortex-M processor, and the medium provided by the embodiments of the present application set the MCR instructions and the CDP instruction according to the common basic operators of the recurrent neural network, wherein the common basic operators comprise the matrix multiplication operator, the vector arithmetic operator, the sigmoid activation operator, the tanh activation operator and the quantization operator; configure the internal register of the recurrent neural network coprocessor through the MCR instructions; and enable the common basic operators of the recurrent neural network through the CDP instruction on the basis of the configured internal register, thus solving the problems of low efficiency, high cost and inflexibility of the recurrent neural network algorithm in the execution of the processor.

### Technical Effects

1. The basic operators needed to execute the recurrent neural network through the coprocessor instruction set are realized, and the cost of hardware reconstruction can be reduced for the application fields with variable algorithms.
2. By extracting the data from the local buffer through the coprocessor instruction set, the reuse rate of the local buffer data is improved, and the bandwidth demand of the coprocessor accessing the main memory is reduced, thus reducing the power consumption and cost of the whole system.
3. Using the coprocessor to handle artificial intelligence operations and specifically transmitting instructions through a dedicated coprocessor interface for a CPU can avoid a delay problem caused by bus congestion and improve the system efficiency.
4. The coprocessor instruction set has flexible design and large reserved space, which is convenient to add additional instructions when upgrading hardware.

### BRIEF DESCRIPTION OF THE DRAWINGS

The accompanying drawings illustrated herein serve to provide a further understanding of the present application and constitute a part of the present application, and the illustrative embodiments of the present application and together with the description thereof serve to explain the present application, and do not constitute inappropriate limitation to the present application. In the drawings:

FIG. 1 is a flow chart of steps of a method for accelerating a recurrent neural network based on a Cortex-M processor according to an embodiment of the present application;

FIG. 2 is a schematic diagram of a specific multiply and accumulate operation without a write-back function;

FIG. 3 is a schematic diagram showing operation of a matrix multiplication operator of the recurrent neural network;

FIG. 4 is a structural block diagram of a system for accelerating a recurrent neural network based on a Cortex-M processor according to an embodiment of the present application; and

FIG. 5 is a schematic diagram of an internal structure of an electronic device according to an embodiment of the present application.

Reference numerals: 41 refers to instruction set setting module; and 42 refers to instruction set execution module.

### DETAILED DESCRIPTION

To make the objects, technical solutions, and advantages of the present application clearer, the following describes and illustrates the present application with reference to the accompanying drawings and embodiments. It should be understood that the specific embodiments described herein are merely illustrative of the present application and are not intended to limit the present application. Based on the embodiments provided by the present application, all other embodiments obtained by those of ordinary skills in the art without going through any creative effort shall fall within the protection scope of the present application.

Obviously, the accompanying drawings in the following description are only some examples or embodiments of the present application. For those of ordinary skill in the art, the present application can also be applied to other similar situations according to these accompanying drawings without any creative effort. Moreover, it is understandable that although the efforts made in the development process may be complicated and lengthy, for those of ordinary skills in the art related to the contents disclosed in the present application, some changes in design, manufacture or production based on the technical contents disclosed in the present application are only conventional technical means, and should not be understood as the contents disclosed in the present application are insufficient.

In the present application, reference to an embodiment means that a specific feature, structure or character described in connection with the embodiment may be comprised in at least one embodiment of the present application. The appearance of this phrase in various places in the specification does not necessarily refer to the same embodiment, nor is it an independent or alternative embodiment mutually exclusive with other embodiments. It is explicitly and implicitly understood by those of ordinary skills in the art that the embodiments described in the present application may be combined with other embodiments without conflict.

Unless otherwise defined, the technical terms or scientific terms involved in the present application should have general meanings understood by those of ordinary skills in the technical field to which the present application belongs. Similar words such as “a”, “an”, “a kind of” and “the” involved in the present application do not mean quantity limitation, but can mean singular or plural. The term “comprise”, “include” and “provided with” and any variations thereof involved in the present application are intended to cover non-exclusive inclusion. For example, processes, methods, apparatuses, products or devices including a series of steps or units are not limited to the listed steps or units, but further include steps or units not listed, or further include other steps or units inherent to these processes, methods, products or devices. “Connection”, “connected”, “couple” and similar terms involved in the present application are not limited to a physical or mechanical connection, but may comprise an electrical connection, regardless of a direct or indirect connection. “A plurality” involved in the present application means two or more. “And/or” describes a relationship of related objects, indicating that there may be three kinds of relationships. For example, “A and/or B” can indicate that there are three situations: A alone, A and B at the same time, and B alone. The character “/” generally indicates that the context object is an “OR” relationship. The terms “first”, “second” and “third” involved in the present application only distinguish similar objects, and do not represent the specific ordering of objects.

In the prior art, the simplest method is to directly use a processor of a MCU to process calculation of these recurrent neural networks. However, the existing ARM instruction set contains some simple independent operation instructions, which can perform some basic processing operations. However, for large-scale operations such as matrix multiplication or complex operations such as tanh activation, it is inefficient. For example, many instructions need to be executed repeatedly every time the matrix multiplication is performed, and parallel operations are not possible, so the efficiency of processing a large number of operations is very low. For example, it takes more than 400 clock cycles to calculate tanh activation (in a data format of single-precision floating-point number) by a using math.h library.

On one hand, there is a dedicated hardware accelerator designed to directly use the processor of the MCU to process these operations. Using an Application Specific Integrated Circuit ASIC to build a dedicated hardware accelerator can obviously improve the computing efficiency. It only takes dozens of clock cycles for a dedicated tanh hardware accelerator to calculate the tanh activation, but the recurrent neural networks have many variants LSTM (Long Short-Term Memory), GRU (Gated Recurrent Unit), or the like. Different application scenarios need to use different network structures, and it will cost a lot to design the corresponding hardware accelerator for each structure.

On the other hand, the data to be processed is sent to the cloud, and a result is returned to a user end after the calculation, and the general workflow of the solution of the prior art comprises the steps of edge data acquisition, edge data transmission, cloud data reception, cloud data processing, cloud data transmission, edge data reception, and the like. However, the use of cloud computing will result in the bandwidth cost and delay of long-distance transmission. In some occasions with high requirements for real-time, such as deep learning in industry to detect the occurrence of arc, it needs to identify onset of arcing as soon as possible and cut off a power supply to protect electrical equipment. Excessive delay will increase the occurrence of danger, so the cloud computing solution has certain limitations.

In order to realize a recurrent neural network accelerator which can work on the MCU and has certain flexibility, the present invention provides a lightweight recurrent neural network coprocessor instruction set, which can realize matrix multiplication, vector multiplication, vector addition, sigmoid activation, tanh activation and quantization operators in the recurrent neural network, support different algorithms without redesigning hardware structure, and meet the requirements of the MCU for timeliness.

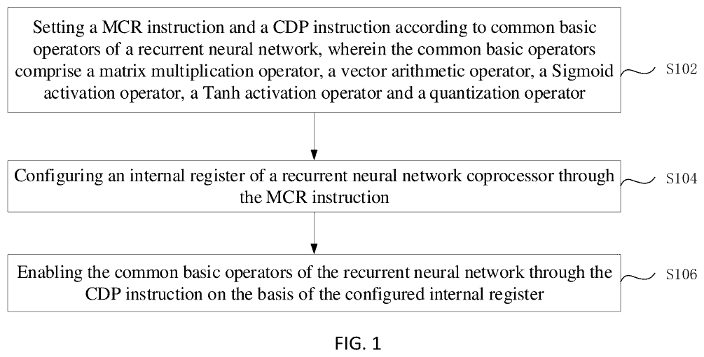

An embodiment of the present application provides a method for accelerating a recurrent neural network based on a Cortex-M processor. FIG. 1 is a flow chart of steps of the method for accelerating the recurrent neural network based on the Cortex-M processor according to the embodiment of the present application. As shown in FIG. 1, the method comprises the following steps of:

Step S102: setting MCR instructions and a CDP instruction according to common basic operators of the recurrent neural network, wherein the common basic operators comprise a matrix multiplication operator, a vector arithmetic operator, a sigmoid activation operator, a tanh activation operator and a quantization operator.

Specifically, Table 1 shows a set of partial CDP instructions of the recurrent neural network coprocessor. As shown in Table 1, each CDP instruction corresponds to two operands and a corresponding instruction function.

TABLE 1

| Operand 1 | Operand 2 | Instruction function |
|---|---|---|
| 0000 | 000 | Operation of reading main memory data to |
| | | local buffer operation |
| 0000 | 001 | Operation of writing the local buffer data |
| | | to the main memory |
| 0001 | 011 | Multiply and accumulate operation without |
| | | write-back function |
| 0001 | 111 | Multiply and accumulate operation with |
| | | write-back function |
| 0010 | 001 | Vector multiplication operation |
| 0010 | 010 | Vector addition operation |
| 0011 | 001 | Sigmoid activation operation |
| 0011 | 010 | tanh activation operation |
| 0011 | 011 | Operation of converting from 32-bit single- |
| | | precision floating-point number (FP32) to |
| | | 16-bit integer number (INT16) |
| 0011 | 100 | Operation of converting from 16-bit |
| | | integer (INT16) to 32-bit single- |
| | | precision floating-point number (FP32) |

Step S104: configuring an internal register of a recurrent neural network coprocessor through the MCR instructions; and

Step S106: enabling the common basic operators of the recurrent neural network through the CDP instruction on the basis of the configured internal register.

Through the step S102 to the step S106 in the embodiment of the present application, the problems of low efficiency, high cost and inflexibility of the recurrent neural network algorithm in the execution of the processor are solved. The basic operators needed to execute the recurrent neural network through the coprocessor instruction set are realized, and the cost of hardware reconstruction can be reduced for the application fields with variable algorithms. By extracting the data from the local buffer through the coprocessor instruction set, the reuse rate of the local buffer data is improved, and the bandwidth demand of the coprocessor accessing the main memory is reduced, thus reducing the power consumption and cost of the whole system. Using the coprocessor to handle artificial intelligence operations and specifically transmitting instructions through a dedicated coprocessor interface for a CPU can avoid a delay problem caused by bus congestion and improve the system efficiency. The coprocessor instruction set has flexible design and large reserved space, which is convenient to add additional instructions when upgrading hardware.

In some embodiments, the step of configuring the internal register of the recurrent neural network coprocessor through the MCR instructions comprises:
configuring a local buffer address of weight data to a first register, configuring a local buffer address of feature data to a second register, configuring stride block information to a scale register, and configuring an operation mode to a control register through a first MCR instruction.

Specifically, the local buffer address of the weight data is configured to a DLA_ADDR1 register through the first MCR instruction; the local buffer address of the feature data is configured to a DLA_ADDR2 register; a stride block number and a stride block interval are configured to a DLA_SIZE register; and the operation mode is configured to a DLA_Control register.

The stride block information comprises the stride block number, the stride block interval and a stride block size, wherein the stride block number is DLA_SIZE[15:0], which indicates a number of sets of feature data. The stride block interval is DLA_SIZE[23:16], which indicates an interval between each set of feature data, has a granularity of 128 Bits (16 Bytes), indicates continuous access when it is configured to 0; otherwise, the actual stride size is (DLA_SIZE[23:16]+1) *16 bytes. The stride block size is fixed at 128 Bits (16 Bytes). Therefore, the feature data of this operation is the stride block number*the stride block size, that is, DLA_SIZE[15:0]*16 Bytes. In addition, a weight number of each operation is fixed at 512 Bits (64 Bytes).

The operation mode is DLA_Control[0], which indicates that a multiply and accumulate unit is in the mode of 8-bit integer multiplication and 16-bit integer addition (INT8*INT8+INT16) when it is configured as 0, and indicates that the multiply and accumulate unit is in the mode of 16-bit integer multiplication and 32-bit integer addition (INT16*INT16+INT32) when it is configured as 1. The write-back precision is DLA_Control [1], which writes back with 8 bits in the operation mode 0 and written back with 16 bits in the operation mode 1 when it is configured as 0; and writes back with 16 bits in the operation mode 0 and written back with 32 bits in the operation mode 1 when it is configured as 1.

After the configuration, the multiply and accumulate operation without a write-back function may be enabled by using the CDP 0001 011 instruction.

It should be noted that the without a write-back function here means that the obtained result may be stored in a temporary cache instead of being written back to the local buffer, and may be used as an initial value of next multiply and accumulate operation.

Examples are as follows:

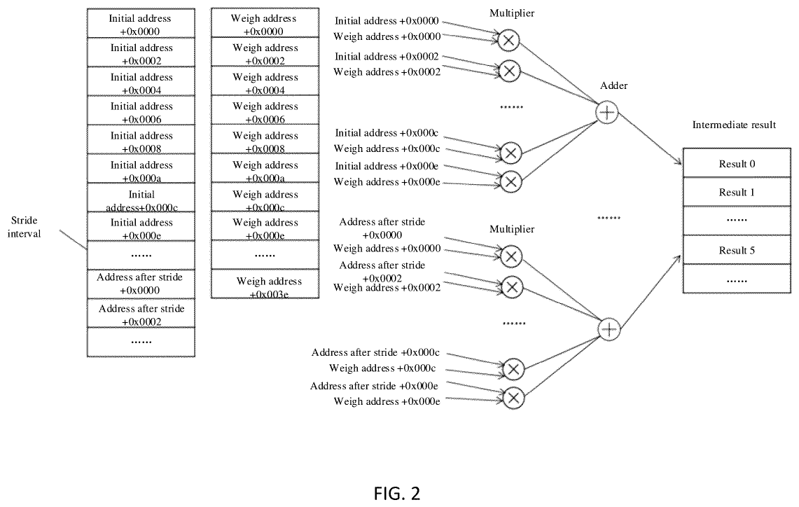

FIG. 2 is a schematic diagram of the specific multiply and accumulate operation without a write-back function. FIG. 2 shows the operation process in the case that the operation mode DLA_Control[0] is configured to as 1, and the write-back precision is configured as 0 (16 bits), wherein the local buffer has a width of 16 bits. Therefore, each address corresponds to one 16-bit data.

Each operation may take 64 Bytes of weight data from the given address of the weight data, that is, 32 numbers (16 bits for each data), and take several sets of feature data with granularity of 16 Bytes (up to 16 sets, that is, 256 Bytes) from the initial address of the feature data. Each set (8 numbers) of feature data may be multiplied by the weight data of 64 Bytes in sequence and then added, and four intermediate results may be obtained, and finally [4*number of feature data sets] intermediate results are obtained, and the obtained intermediate results are stored in the temporary buffer for the initial value of next multiply and accumulate operation.

Preferably, on the basis of the above, an overflow mode may also be configured to the DLA_Control register through the first MCR instruction. After the configuration, the CDP 0001 111 instruction may be used to enable the multiply and accumulate operation with the write-back function, and write the final calculation result from the temporary cache back to the local buffer.

The local buffer address of the first vector set is configured to the first register, the local buffer address of the second vector set is configured to the second register, the local buffer address of the write-back information is configured to the third register, and the stride block information is configured to the scale register through the second MCR instruction.

Specifically, the local buffer address of the first vector set is configured to the DLA_ADDR1 register, the local buffer address of the second vector set is configured to the DLA_ADDR2 register, the local buffer address of the write-back information is configured to the DLA_ADDR3 register, and the stride block information is configured to the DLA_SIZE register through the second MCR instruction.

The stride block information comprises the stride block number and the stride block size, wherein the stride block number is DLA_SIZE[15:0], which indicates the number of sets of feature data. The stride block size is fixed at 128 Bits (16 Bytes). Therefore, the feature data of this operation is the stride block number * the stride block size, that is,

DLA_SIZE[15:0]*16 Bytes.

After the configuration, the vector multiplication operation may be enabled by using the CDP 0010 001 instruction. Alternatively, the vector addition operation may be enabled by using the CDP 0010 010 instruction.

The local buffer address of the input data is configured to the first register, the local buffer address of the write-back information is configured to the second register, and the stride block information is configured to the scale register through the third MCR instruction.

Specifically, the local buffer address of the input data is configured to the DLA_ADDR1 register, the local buffer address of the write-back information is configured to the DLA_ADDR2 register, and the stride block information is configured to the DLA_SIZE register through the third MCR instruction.

The stride block information comprises the stride block number and the stride block size, wherein the stride block number is DLA_SIZE[15:0], which indicates the number of sets of feature data. The stride block size is fixed at 128 Bits (16 Bytes). Therefore, the feature data of this operation is the stride block number*the stride block size, that is, DLA_SIZE[15:0]*16 Bytes.

After the configuration, the sigmoid activation operation may be enabled by using the CDP 0011 001 instruction. Alternatively, the tanh activation operation may be enabled by using the CDP 0011 010 instruction. Alternatively, the quantization operation may be enabled by using the CDP 0011 011 instruction or the CDP 0011 100 instruction.

In some embodiments, after the configuring the internal register of the recurrent neural network coprocessor through the first MCR instruction in step S104, the method further comprises:
enabling the matrix multiplication operator of the recurrent neural network through the CDP instruction, partitioning a matrix of the feature data according to the stride block information, and partitioning a matrix of the weight data according to a preset weight quantity; and
performing a corresponding multiply and accumulate operation on the partitioned matrix of the feature data and the partitioned matrix of the weight data according to the operation mode.

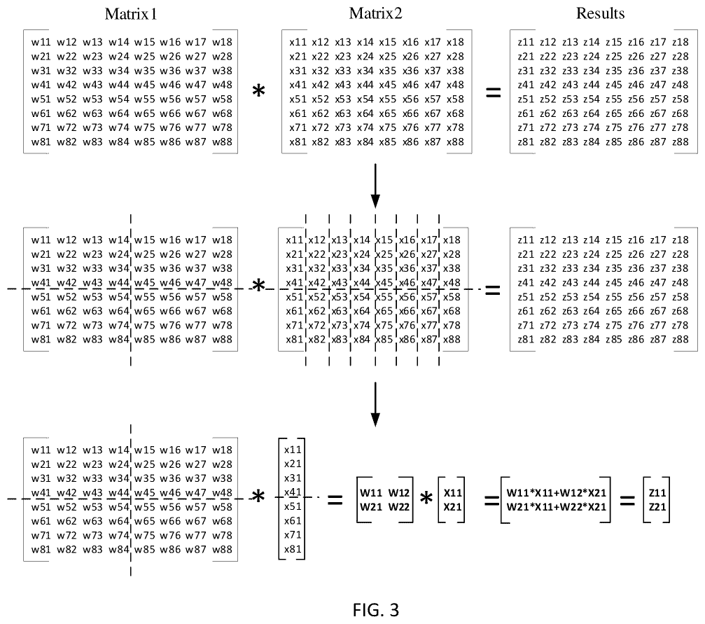

Specifically FIG. 3 is a schematic diagram showing operation of the matrix multiplication operator of the recurrent neural network. As shown in FIG. 3, the matrix multiplication operator of the recurrent neural network is enabled through the CDP 0001 011 instruction or the CDP 0001 111 instruction. Because an amount of data calculated by a single multiply and accumulate instruction of the coprocessor is limited, it is necessary to split the operation, so as to conform to the working mode of hardware.

Matrix 1 is weight data, matrix 2 is feature data, and a size of each data in the two matrices is 32 Bits. Since the stride block size (feature block size) is fixed at 128 Bits, it is necessary to partition the matrix 2 with a granularity of 4 and divide by 4*1 to obtain 16 matrix blocks X11, X12, . . . , X27, and X28. Since a weight number of each multiply and accumulate operation is fixed at 512 Bits, the matrix 1 is divided by 4*4 to get four matrix blocks W11, W12, W21 and W22. The 4*4 matrix blocks are multiplied and accumulated with 4*1 matrix blocks in turn to get sixteen matrix blocks Z11, Z12, . . . , Z27, and Z28, which is the final result of the matrix multiplication operator operation.

In some embodiments, after the configuring the internal register of the recurrent neural network coprocessor through the second MCR instruction in step S104, the method further comprises:
enabling the vector arithmetic operator of the recurrent neural network through the CDP instruction, and adding or multiplying values in the first vector set and the second vector set one by one according to the stride block information; and
writing an arithmetic result back to a local buffer according to the write-back information.

Specifically, the vector addition operator of the recurrent neural network is enabled through the CDP 0010 010 instruction. Alternatively, the vector multiplication operator of the recurrent neural network is enabled through the CDP 0010 001 instruction.

Values in the first vector set and the second vector set are added or multiplied one by one according to the stride block information, wherein the stride block information comprises the stride block number and the stride block size, wherein the stride block number is DLA_SIZE[15:0], which indicates the number of sets of the feature data; and the stride block size is fixed at 128 Bits (16 Bytes). Therefore, the number of the feature data of this operation is the stride block number*the stride block size, that is, DLA_SIZE[15:0]*16 Bytes.

The arithmetic result is written back to the local buffer according to the write-back information.

In some embodiments, after the configuring the internal register of the recurrent neural network coprocessor through the third MCR instruction in step S104, the method further comprises:
enabling the sigmoid activation operator of the recurrent neural network through the CDP instruction, inputting the input data into a sigmoid activation function sigmoid

$$( X ) = \frac{1}{1 + {e}^{- x}}$$

according to the stride block information, and returning a result value, wherein e is a natural constant in mathematics and x is the input data; and
writing the result value back to a local buffer according to the write-back information.

Specifically, the sigmoid activation operator of the recurrent neural network is enabled through the CDP 0011 001 instruction.

The input data is input to the sigmoid activation function sigmoid

$$( X ) = \frac{1}{1 + {e}^{- x}}$$

according to the stride block information, and the result value is returned. The stride block information comprises the stride block number and the stride block size, wherein the stride block number is DLA_SIZE[15:0], which indicates the number of sets of the feature data; and the stride block size is fixed at 128 Bits (16 Bytes). Therefore, the number of the feature data of this operation is the stride block number*the stride block size, that is, DLA_SIZE[15:0]*16 Bytes.

The result value is written back to the local buffer according to the write-back information.

In some embodiments, after the configuring the internal register of the recurrent neural network coprocessor through the third MCR instruction in step S104, the method further comprises:
enabling the tanh activation operator of the recurrent neural network through the CDP instruction, inputting the input data into a tanh activation function tanh

$$( X ) = \frac{{e}^{x} - {e}^{- x}}{{e}^{x} + {e}^{- x}} = 2$$

sigmoid(2x)−1 according to the stride block information, and returning a result value, wherein e is a natural constant in mathematics and x is the input data; and writing the result value back to a local buffer according to the write-back information.

Specifically, the tanh activation operator of the recurrent neural network is enabled through the CDP 0011 010 instruction.

The input data is input to the tanh activation function tanh

$$( X ) = \frac{{e}^{x} - {e}^{- x}}{{e}^{x} + {e}^{- x}} = 2$$

sigmoid(2x)−1 according to the stride block information, and the result value is returned. The stride block information comprises the stride block number and the stride block size, wherein the stride block number is DLA_SIZE[15:0], which indicates the number of sets of the feature data; and the stride block size is fixed at 128 Bits (16 Bytes). Therefore, the number of the feature data of this operation is the stride block number*the stride block size, that is, DLA_SIZE[15:0]*16 Bytes.

The result value is written back to the local buffer according to the write-back information.

In some embodiments, after the configuring the internal register of the recurrent neural network coprocessor through the third MCR instruction in step S104, the method further comprises:
enabling the quantization operator of the recurrent neural network through the CDP instruction, and converting a 32-bit single-precision floating-point number conforming to an IEEE-754 standard in the input data into a 16-bit integer according to the stride block information, or converting a 16-bit integer in the input data into a 32-bit single-precision floating-point number conforming to the IEEE-754 standard; and
writing a conversion result back to a local buffer according to the write-back information.

Specifically, the quantization operator of the recurrent neural network is enabled through the CDP 0011 011 instruction or the CDP 0011 100 instruction.

The 32-bit single-precision floating-point number conforming to the IEEE-754 standard in the input data is converted into the 16-bit integer according to the stride block information, or the 16-bit integer in the input data is converted into the 32-bit single-precision floating-point number conforming to the IEEE-754 standard. The stride block information comprises the stride block number and the stride block size, wherein the stride block number is DLA_SIZE[15:0], which indicates the number of sets of the feature data; and the stride block size is fixed at 128 Bits (16 Bytes). Therefore, the number of the feature data of this operation is the stride block number*the stride block size, that is, DLA_SIZE[15:0]*16 Bytes.

The conversion result is written back to the local buffer according to the write-back information.

In some embodiments, the method further comprises:
configuring a main memory address to a first register, configuring a local buffer address to a second register, and configuring stride block information to a scale register through a fourth MCR instruction;
enabling a data reading operation through the CDP instruction, and reading data in the main memory address into the local buffer according to the stride block information; and enabling a data writing operation through the CDP instruction, and writing data in the local buffer into the main memory address according to the stride block information.

Specifically, the main memory address is configured to the DLA_ADDR1 register through the fourth MCR instruction; the local buffer address is configured to the DLA_ADDR2 register; and the stride block number, the stride block interval and the stride block size are configured to the DLA_SIZE register.

The stride block information comprises the stride block number, the stride block interval and the stride block size, wherein the stride block number is DLA_SIZE[15:0], which indicates the times of reading/writing; the stride block interval is DLA_SIZE[23:16],which indicates the interval between reads/writes, with a granularity of 32 Bits (4 Bytes), which indicates continuous access when it is configured as 0; otherwise, the actual stride size is (DLA_SIZE[23:16]+1)*4 bytes. The stride block size is DLA_SIZE[25:24], which indicates the number of reads/writes each time. The block size is 4 Bytes when DLA_SIZE[25:24] is 2′d00, the block size is 8 Bytes when DLA_SIZE [25:24] is 2′d01, and the block size is 16 Bytes when DLA_SIZE[25:24] is 2′d10. Therefore, the feature data amount of this read/write operation is the stride block number*the stride block size, that is, DLA_SIZE[15:0]*DLA_SIZE[25:24].

A data reading operation is enabled through the CDP 0000 000 instruction, and the data in the main memory address is read into the local buffer according to the stride block information.

A data writing operation is enabled through the CDP 0000 001 instruction, and the data in the local buffer is written into the main memory address according to the stride block information.

It is to be understood that the steps shown in the flow above or the flow chart of the accompanying drawings may be executed in a computer system such as a set of computer-executable instructions, and, although a logical sequence is shown in the flow chart, in some cases, the steps shown or described may be executed in a sequence different from the sequence herein.

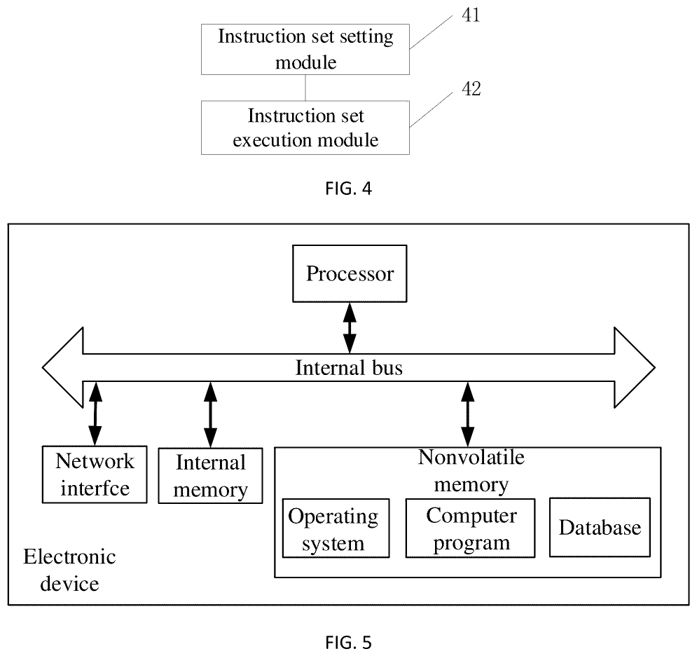

An embodiment of the present application provides a system for accelerating a recurrent neural network based on a Cortex-M processor. FIG. 4 is a structural block diagram of the system for accelerating the recurrent neural network based on the Cortex-M processor according to the embodiment of the present invention. As shown in FIG. 4, the system comprises an instruction set setting module 41 and an instruction set execution module 42.

The instruction set setting module 41 sets MCR instructions and a CDP instruction according to common basic operators of the recurrent neural network, wherein the common basic operators comprise a matrix multiplication operator, a vector arithmetic operator, a sigmoid activation operator, a tanh activation operator and a quantization operator.

The instruction set execution module 42 configures an internal register of a recurrent neural network coprocessor through the MCR instructions; and the instruction set execution module 42 enables the common basic operators of the recurrent neural network through the CDP instruction on the basis of the configured internal register.

Through the instruction set setting module 41 and the instruction set execution module 42 in the embodiment of the present application, the problems of low efficiency, high cost and inflexibility of the recurrent neural network algorithm in the execution of the processor are solved. The basic operators needed to execute the recurrent neural network through the coprocessor instruction set are realized, and the cost of hardware reconstruction can be reduced for the application fields with variable algorithms. By extracting the data from the local buffer through the coprocessor instruction set, the reuse rate of the local buffer data is improved, and the bandwidth demand of the coprocessor accessing the main memory is reduced, thus reducing the power consumption and cost of the whole system. Using the coprocessor to handle artificial intelligence operations and specifically transmitting instructions through a dedicated coprocessor interface for a CPU can avoid a delay problem caused by bus congestion and improve the system efficiency. The coprocessor instruction set has flexible design and large reserved space, which is convenient to add additional instructions when upgrading hardware.

It should be noted that the above modules can be function modules or program modules, which can be realized by software or hardware. For modules implemented by hardware, the above modules may be located in the same processor; or the above modules may also be located in different processors in any combination.

This embodiment also provides an electronic device, comprising a memory and a processor, wherein the memory is stored with a computer program, and the processor is configured to run the computer program to execute the steps in any of the above method embodiments.

Optionally, the electronic device above may also comprise a transmission device and an input/output device, wherein the transmission device is connected with the processor above, and the input/output device is connected with the processor above.

It should be noted that for a specific example in this embodiment, reference may be made to the examples described in the foregoing embodiments and optional embodiments, which will not be elaborated in this embodiment.

In addition, in combination with the method for accelerating the recurrent neural network based on the Cortex-M processor in the above embodiment, the embodiments of the present application may provide a storage medium for implementation. A computer program is stored on the storage medium. The computer program, when executed by a processor, realizes any one of the method for accelerating the recurrent neural network based on the Cortex-M processor in the above embodiments.

In one embodiment, a computer device is provided, and the computer device may be a terminal. The computer device comprises a processor, a memory, a network interface, a display screen and an input device connected via a system bus. The processor of the computer device is configured for providing calculating and control capabilities. The memory of the computer device comprises a nonvolatile storage medium and an internal memory. The nonvolatile storage medium stores an operating system and a computer program. The internal memory provides an environment for the operation of the operating system and the computer program in the nonvolatile storage medium. The network interface of the computer device is configured for communicating with external terminals through network connection. The computer program, when executed by a processor, realizes a method for accelerating a recurrent neural network based on a Cortex-M processor. The display screen of the computer device may be a liquid crystal display or an electronic ink display, and the input device of the computer device may be a touch layer covered on the display, or a key, a trackball or a touchpad arranged on a shell of the computer device, and may also be an external keyboard, an external touchpad or an external mouse, or the like.

In one embodiment, FIG. 5 is a schematic diagram of an internal structure of an electronic device according to an embodiment of the present application. As shown in FIG. 5, an electronic device is provided. The electronic device may be a server, and an internal structure diagram thereof may be shown in FIG. 5. The electronic device comprises a processor, a network interface, an internal memory and a nonvolatile memory connected by an internal bus, wherein the nonvolatile memory stores an operating system, a computer program and a database. The processor is configured for providing calculating and control capabilities. The network interface is configured for communicating with external terminals through network connection. The internal memory is configured for providing an environment for the operation of the operating system and the computer program. The computer program, when executed by the processor, realizes a method for accelerating a recurrent neural network based on a Cortex-M processor is realized. The database is configured for storing data.

Those skilled in the art can understand that the structure shown in FIG. 5 is only a block diagram of some structures related to the solutions of the present application and does not constitute a limitation on the computer device to which the solutions of the present application is applied. The computer device may comprise more or fewer components than those shown in the figure, or may combine some components, or have different component arrangements.

Those having ordinary skills in the art should understand that all or a part of the flow of the methods in the above embodiments may be implemented by instructing relevant hardware through a computer program. The computer program may be stored in a nonvolatile computer-readable storage medium which, when being executed, may include the flow of the above-mentioned method embodiments. Any reference to the memory, storage, database or other media used in various embodiments provided by the present application may comprise nonvolatile and/or volatile memories. The nonvolatile memory may comprise a read-only memory (ROM), a programmable ROM (PROM), an electrically programmable ROM (EPROM), an electrically erasable programmable ROM (EEPROM) or a flash memory. The volatile memory may comprise a random access memory (RAM) or an external cache memory. By way of illustration rather than limitation, the RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM) and a memory bus RAM (RDRAM), or the like.

It should be understood by those skilled in the art that the technical features of the above embodiments can be combined in any way. In order to simplify the description, not all the possible combinations of the technical features of the above embodiments are described. However, as long as there is no contradiction in the combinations of these technical features, they should be considered as the scope recorded in this specification.

The above embodiments merely express several embodiments of the present application, and the descriptions thereof are more specific and detailed, but cannot be understood as a limitation to the scope of the invention patent. It should be noted that those of ordinary skills in the art may make a plurality of decorations and improvements without departing from the conception of the present application, and these decorations and improvements shall all fall within the protection scope of the present application. Therefore, the protection scope of the patent according to the present application shall be subjected to the claims appended.

What is claimed is:

1. A method for accelerating a recurrent neural network, comprising:
setting MCR (Move to Coprocessor from arm Register) instructions and a Coprocessor Data Processing instruction (CDP) with operators of the recurrent neural network, wherein the operators comprise a matrix multiplication operator, a vector arithmetic operator, a sigmoid activation operator, a tanh activation operator and a quantization operator;
configuring internal registers of a recurrent neural network coprocessor through the MCR instructions; and
executing an operation using one of the operators of the recurrent neural network through the Coprocessor Data Processing instruction on the basis of the configured internal registers.

2. The method according to claim 1, wherein the internal registers comprise a first register, a second register, a third register, a scale register and a control register, the MCR instructions comprise a first MCR instruction, a second MCR instruction and a third MCR instruction, and the step of configuring the internal registers of the recurrent neural network coprocessor through the MCR instructions comprises:
configuring, through the first MCR instruction, a local buffer address of weight data to the first register, a local buffer address of feature data to the second register, stride block information to the scale register, and an operation mode and a write-back precision to the control register;
configuring, through the second MCR instruction, a local buffer address of a first vector set to the first register,-a local buffer address of a second vector set to the second register, a local buffer address of write-back information to the third register, and the stride block information to the scale register; and
configuring, through the third MCR instructions, a local buffer address of input data to the first register, the local buffer address of the write-back information to the second register, and the stride block information to the scale register.

3. The method according to claim 2, wherein after the step of configuring, through the first MCR instruction, the local buffer address of weight data to the first register, the local buffer address of feature data to the second register, the stride block information to the scale register, and the operation mode and the write-back precision to the control register, the method further comprises:
executing an operation using the matrix multiplication operator of the recurrent neural network through the Coprocessor Data Processing instruction, partitioning a matrix of the feature data according to the stride block information, and partitioning a matrix of the weight data according to a preset weight quantity; and
performing a corresponding multiply and accumulate operation on the partitioned matrix of the feature data and the partitioned matrix of the weight data according to the operation mode.

4. The method according to claim 2, wherein after the step of configuring, through the second MCR instruction, the local buffer address of the first vector set to the first register, the local buffer address of the second vector set to the second register, the local buffer address of write-back information to the third register, and the stride block information to the scale register, the method further comprises:
executing an operation using the vector arithmetic operator of the recurrent neural network through the Coprocessor Data Processing instruction, and adding or multiplying values in the first vector set and the second vector set one by one according to the stride block information; and
writing an arithmetic result back to a local buffer according to the write-back information.

5. The method according to claim 2, wherein after the step of configuring, through the third MCR instruction, the local buffer address of input data to the first register, the local buffer address of the write-back information to the second register, and the stride block information to the scale register, the method further comprises:
executing an operation using the sigmoid activation operator of the recurrent neural network through the Coprocessor Data Processing instruction, inputting the input data into a sigmoid activation function sigmoid
$$( X ) = \frac{1}{1 + {e}^{- x}}$$
according to the stride block information, and returning a result value; and
writing the result value back to a local buffer according to the write-back information.

6. The method according to claim 2, wherein after the step of configuring, through the third MCR instruction, the local buffer address of input data to the first register, the local buffer address of the write-back information to the second register, and the stride block information to the scale register, the method further comprises:
executing an operation using the tanh activation operator of the recurrent neural network through the Coprocessor Data Processing instruction, inputting the input data into a tanh activation function tanh
$$( X ) = \frac{{e}^{x} - {e}^{- x}}{{e}^{x} + {e}^{- x}} = 2$$
sigmoid(2x)−1 according to the stride block information, and returning a result value; and
writing the result value back to a local buffer according to the write-back information.

7. The method according to claim 2, wherein after the step of configuring, through the third MCR instruction, the local buffer address of input data to the first register, the local buffer address of the write-back information to the second register, and the stride block information to the scale register, the method further comprises:
executing an operation using the quantization operator of the recurrent neural network through the Coprocessor Data Processing instruction, and converting a 32-bit single-precision floating-point number conforming to an IEEE-754 standard in the input data into a 16-bit integer according to the stride block information, or converting a 16-bit integer in the input data into a 32-bit single-precision floating-point number conforming to the IEEE-754 standard; and
writing a conversion result back to a local buffer according to the write-back information.

8. The method according to claim 1, wherein the method further comprises:
configuring, through a fourth MCR instruction, a main memory address to a first register, an address of a local buffer to a second register, and stride block information to a scale register;
executing a data reading operation through the Coprocessor Data Processing instruction, and reading data in the main memory address into the local buffer according to the stride block information; and
executing a data writing operation through the Coprocessor Data Processing instruction, and writing data in the local buffer into the main memory address according to the stride block information.

9. A system for accelerating a recurrent neural network, wherein the system comprises an instruction set setting processor and an instruction set execution processor;
the instruction set setting processor sets MCR instructions and a Coprocessor Data Processing instruction with operators of the recurrent neural network, wherein the operators comprise a matrix multiplication operator, a vector arithmetic operator, a sigmoid activation operator, a tanh activation operator and a quantization operator;
the instruction set execution processor configures internal registers of a recurrent neural network coprocessor through the MCR instructions; and
the instruction set execution processor executes an operation using the common basic operators of the recurrent neural network through the Coprocessor Data Processing instruction on the basis of the configured internal registers. cm 10. A non-transitory computer-readable storage medium storing a computer program thereon, wherein the computer program, when executed by a processor, implements the method for accelerating the recurrent neural network according to claim 1.
